(19) United States
(12) Patent Application Publication
(10) Pub. No.: US 2025/0284984 A1
(43) Pub. Date: Sep. 11, 2025

(54) KNOWLEDGE BASE ENTITY CLASSIFICATION

(71) Applicant: Roku, Inc., San Jose, CA (US)

(72) Inventors: Chetan PATIL, Sunnyvale, CA (US); Iaroslav ZAITSEV, Pleasanton, CA (US); Ali ALRAHAHLEH, San Jose, CA (US); Abhilash GOPINATH, Milpitas, CA (US); Nima RAD, San Francisco, CA (US)

(73) Assignee: Roku, Inc., San Jose, CA (US)

(21) Appl. No.: 18/596,391

(22) Filed: Mar. 5, 2024

(51) Int. Cl. G06N 5/04

(52) U.S. Cl. CPC G06N 5/04

(57) ABSTRACT

Disclosed herein are system, apparatus, device, method and/or computer program product embodiments, and/or combinations and sub-combinations thereof, for efficient entity classification. In an embodiment, a set of subclasses associated with a particular entity class is obtained via a query service of a knowledge base. A copy of the knowledge base is obtained, the copy of the knowledge base specifying a plurality of entities. The copy of the knowledge base is partitioned into a plurality of partitions, each partition of the plurality of partitions specifying a respective subset of the plurality of entities. For each partition of the plurality of partitions, at least one entity in the respective subset of the plurality of entities is classified with the particular entity class based on the one or more subclasses of the set of subclasses.

### BACKGROUND

### Field

This disclosure is generally directed to computer-implemented systems for entity classification.

### SUMMARY

Provided herein are system, apparatus, device, method and/or computer program product embodiments, and/or combinations and sub-combinations thereof, for efficient entity classification. In an embodiment, a set of subclasses associated with a particular entity class is obtained via a query service of a knowledge base. A copy of the knowledge base is obtained, the copy of the knowledge base specifying a plurality of entities. The copy of the knowledge base is partitioned into a plurality of partitions, each partition of the plurality of partitions specifying a respective subset of the plurality of entities. For each partition of the plurality of partitions, at least one entity in the respective subset of the plurality of entities is classified with the particular entity class based on the one or more subclasses of the set of subclasses.

In an embodiment, obtaining the copy of the knowledge base comprises downloading the copy of the knowledge base, wherein the copy of the knowledge base is included in a first file having a first text-based file format; and converting the copy of the knowledge base to a second text-based file format, wherein the second text-based file format is a newline-delimited format such that each entity of the plurality of entities is specified on a separate, independently-processable line.

In another embodiment, the first text-based file format is a JavaScript Object Notation (JSON) file format and the second-text based file format is a JSON Lines format. In a further embodiment, the first text-based file format is a binary format. The first file may be compressed in any of the commonly-available formats such as bzip2 or gzip.

In yet another embodiment, a determination is made that at least one of a particular entity of the plurality of entities of the knowledge base has been modified or a new entity has been added to the knowledge base after obtaining the copy of the knowledge base; and at least one of the particular entity or the new entity is classified with the particular entity class based on the one or more of the set of subclasses.

In still another embodiment, determining that at least one of the particular entity of the plurality of entities of the knowledge base has been modified or the new entity has been added to the knowledge base comprises obtaining a notification from a streaming application programming interface (API) associated with the knowledge base that indicates that at least one of the particular entity of knowledge base has been modified or the new entity has been added to the knowledge base.

In a further embodiment, a determination is made that at least one second entity in the respective subset of the plurality of entities does not correspond to the particular entity class; and in response to determining that at least one second entity in the respective subset of the plurality of entities does not correspond to the particular entity class, the at least one second entity is classified as being unassigned.

In yet a further embodiment, for each partition of the plurality of partitions: an indication of a number of pageviews of a web page associated with the classified at least one entity is obtained; and a level of popularity of the classified at least one entity is determined based on the indication.

In a further embodiment, the particular entity class comprises one of a film or a television series, the at least one entity comprises a title of the one of the film or the television series, and the set of subclasses comprises a plurality of further sub-classifications of the one of the film or the television series.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a system for efficiently classifying a knowledge base entity, according to some embodiments.

FIG. 4 is a flowchart for a method for efficient entity classification, according to an embodiment.

FIG. 5 is a flowchart for a method for obtaining a copy of a knowledge base, according to an embodiment.

FIG. 6 is a flowchart for a method for classifying a modified or new entity of the knowledge base, according to an embodiment.

FIG. 7 is a flowchart for a method for classifying an entity as being unassigned, according to an embodiment.

FIG. 8 is a flowchart for a method for associating a number of pageviews with a classified entity, according to an embodiment.

FIG. 9 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

A knowledge base (also referred to as a knowledge graph) is a document-oriented database of items (or entities), which represent any kind of topic, concept, or object. Examples of entities include, but are not limited to, films, television series/shows, podcasts, music, books, software applications, games, etc. The knowledge base may comprise any number of entities (e.g., 100s of millions of entities). Accordingly, the size of the knowledge base can be relatively large (e.g., one or more terabytes).

Due to the large size, it is very compute intensive and time consuming to retrieve data from the knowledge base. For instance, conventional techniques maintain a local copy of the entire knowledge base via a database. Setting up and maintaining such a large database can be very expensive, as a large amount of storage is required. Furthermore, executing a query for all entities of a particular entity class, such as a film, can take an inordinate amount of time given the number of entities stored by the database. Often times, such queries time out, and the requested information is not obtained. Moreover, the massive data size of the knowledge base does not lend itself for easy data manipulations.

Embodiments described herein may address some or all of the foregoing issues. For instance, rather than querying the entire knowledge base for all instances of a given data class, smaller and more efficient queries are executed for each entity class that retrieve the subclasses for such entity classes from the knowledge base. Such queries are far less compute intensive. The set of classes correspond to the ontology for a given entity. Once the ontology is generated, the knowledge base entities are classified in accordance with the ontology. To classify the entities of the knowledge base, the knowledge base may be partitioned into different partitions, each comprising a subset of entities. The entities of each partition may be classified, for example, in parallel.

For example, in embodiments, a set of subclasses associated with a particular entity class is obtained via a query service of a knowledge base. A copy of the knowledge base is obtained, wherein the copy of the knowledge base specifies a plurality of entities. The copy of the knowledge base is partitioned into a plurality of partitions, wherein each partition of the plurality of partitions specifies a respective subset of the plurality of entities. For each partition of the plurality of partitions, at least one entity in the respective subset of the plurality of entities is classified with at least one of the particular entity class or one or more subclasses of the set of subclasses.

The techniques described herein improve the functioning of a computing device configured to perform entity classification. For instance, such techniques remove the need to query the entire knowledge base for all instances of a given data class (which can take tens of minutes to execute). Instead, smaller and more efficient queries are executed for each entity class that retrieve the subclasses for such entity classes. Such queries are far less compute intensive and generally take tens of seconds to execute. Moreover, partitioning the knowledge base and classifying the entities on a per partition basis, reduces the burden on various compute resources (e.g., memory, processing cycles, storage, etc.).

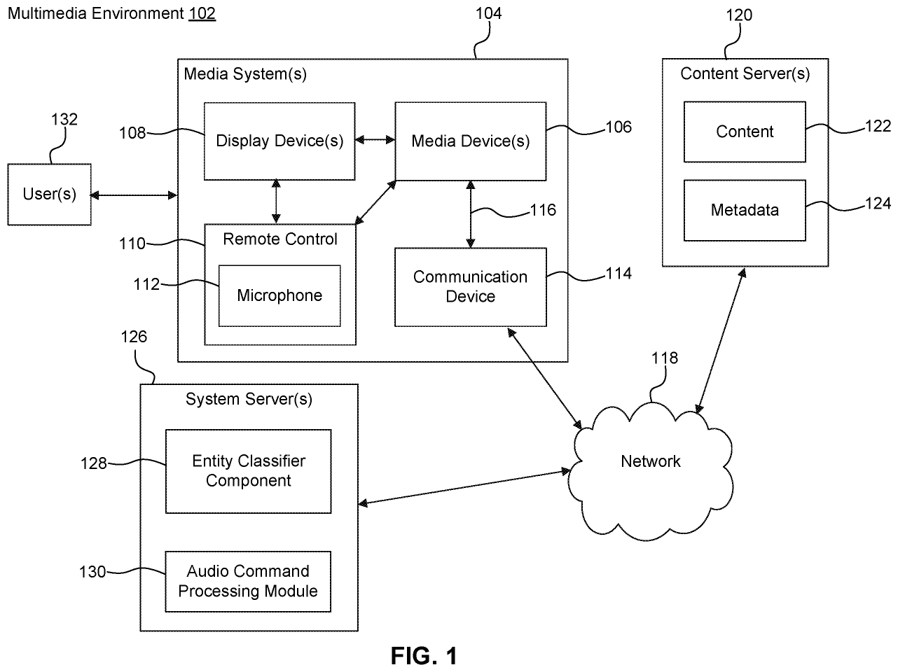

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

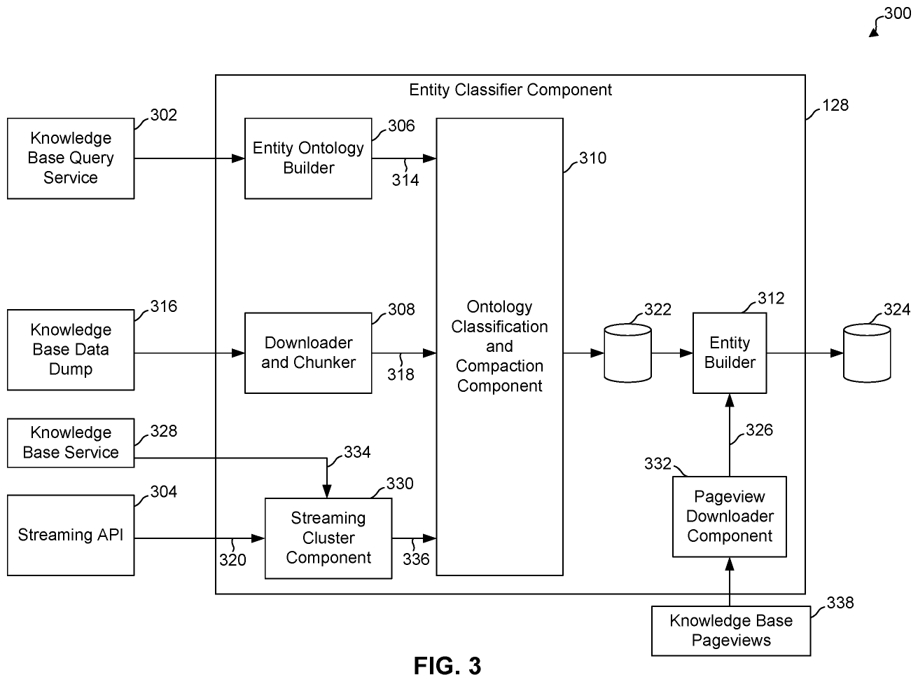

The system servers 126 may include an entity classifier component 128. Entity classifier component 128 may be configured build an ontology for various entities of a knowledge base and classify the entities in accordance with the ontology. The knowledge base (also referred to as a knowledge graph) may be a document-oriented database of items (or entities), which represent any kind of topic, concept, or object. An example of a knowledge base includes, but is not limited to, Wikidata™ published by the Wikimedia Foundation. The knowledge base may be read and editable by both humans and machines. The knowledge base may be structured in accordance with a data model, which structures data about an entity by associating factual claims about the entity using abstractions such as statements (also referred to as SNAKs (some notation about knowledge)). A statement may utilize property-value pairs to express the claims, where a property itself is an entity and a value can be either a data value or another entity. Each item in the knowledge base may be allocated a unique, persistent identifier (e.g., a Q identifier (QID), which comprises a Q followed by one or more integer values), and each property may be associated with a property ID (which comprises a P followed by one or more integer values). The knowledge base may support multiple languages (e.g., the knowledge base may be multilingual). Thus, different versions of the data may be stored in the knowledge base, where each version corresponds to a particular language. The data stored in the knowledge base may be partitioned by language. Certain items and properties may be utilized to structure the ontology of the knowledge base. In an example in which knowledge base is Wikidata™, such items and properties include class (Q16889133), entity (Q35120), “instance of” (P31), and “subclass of” (P279). A class may be representative of a collection of items defined by common characteristics. The items in a class are referred to as instances, and are explicitly related to a class via the “instance of” property (P31). A class subsumed by another is referred to as a subclass. Generally, an item is not normally both an instance of and a subclass of the same class. Examples of entities that may be classified by entity classifier component 128 may include, but are not limited to, films, television series/shows, podcasts, music, books, software applications, games, etc. Such entities may be represented by the titles of such entities. Additional details regarding entity classifier component 128 are provided below with respect to FIG. 3.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

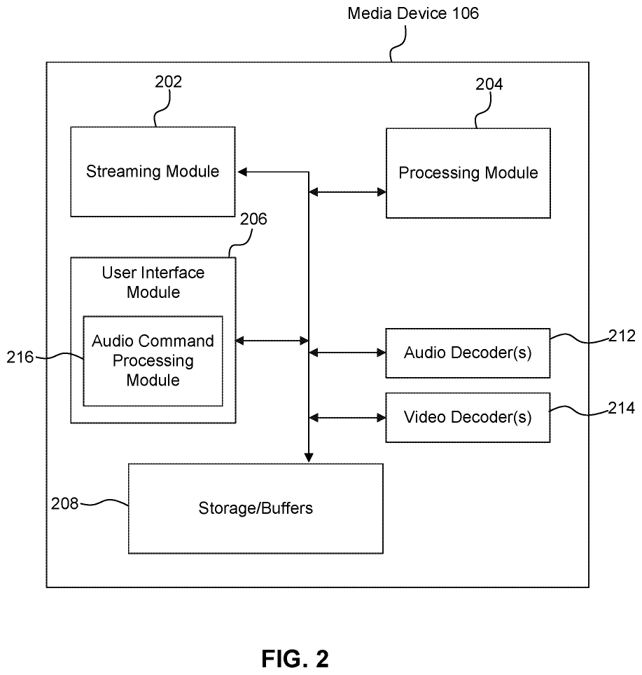

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Knowledge Base Entity Classification

FIG. 3 illustrates a block diagram of a system 300 for efficiently classifying a knowledge base entity, according to some embodiments. As shown in FIG. 3, system 300 comprises an entity classifier component 128, a knowledge base query service 302, a streaming application programming interface (API) 304, and a knowledge base service 328. Entity classifier component 128 may be communicatively coupled to knowledge base query service 302 and streaming API 304 via a network (e.g., network 118). As also shown in FIG. 3, entity classifier component 128 includes an entity ontology builder 306, a downloader and chunker 308, an ontology classification and compaction component 310, an entity builder 312, a streaming cluster component 330, and a pageview downloader component 332.

Knowledge base query service 302 may be configured to receive and execute queries associated with items maintained by the knowledge base. An example of knowledge base query service 302 includes, but is not limited, to Wikidata Query Service™. Entity ontology builder 306 may be configured to generate a query to obtain a list of one or more subclasses for a given entity class. In an example, in which the entity class is a film or television series, knowledge base query service 302 may return a list of one or identifiers (e.g., QID(s)) each corresponding to a further sub-classifications or subgroups of film or television series. The returned set of one or more subclasses corresponds to the ontology for the particular entity class. Entity ontology builder 306 may obtain an ontology for any number of entity classes, including, but not limited to, notable humans, sports teams, music albums, etc. The following code snippet provides an example query to obtain the set of one or more subclasses for the entity class film utilizing Wikidata Query Service™:

SELECT DISTINCT ?qid
WHERE {
VALUES (?parent) { (wd:Q11424) }
?item wdt:P279* ?parent .
BIND(STRAFTER(STR(?item), STR(wd:)) AS ?qid) .
}
ORDER BY xsd:integer(?qid)

In accordance with the code snippet above, P279 represents the “subclass of” property and Q11424 represents the film entity class. Accordingly, the query requests all subclasses of the film entity class. The ontology for a given entity class may be obtained periodically, for example, on an hourly basis, daily basis, weekly basis, etc. Entity ontology builder 306 may provide the obtained ontology (shown as ontology 314)) to ontology classification and compaction component 310.

Downloader and chunker 308 may be configured to download a copy of the knowledge base. For instance, downloader and chunker 308 may download a data dump 316 comprising a copy of the knowledge base from a server that stores data dump 316. Data dumps of the knowledge base may be made available for download on a periodic basis (e.g., every 7 days, every 15 days, etc.). Data dump 316 may specify each of the entities of the knowledge base. The knowledge base may comprise any number of entities (e.g., 100s of millions of entities). Accordingly, the size of the knowledge base can be relatively large (e.g., 1-2 terabytes). Data dump 316 may be stored as a machine and human-readable text-based file format, such as JavaScript Object Notation (JSON). However, it is noted that data dump 316 may be stored in other file formats. For example, data dump 316 may be stored in a binary format or a non-JSON format, such as an NT (N-Triples) or a TTL (Turtle) format. Data dump 316 may also be stored in a compressed format, for example, in a gzip or bzip2 format. In an embodiment, downloader and chunker 308 may download data dump 316 in a concurrent manner, where multiple transmission control protocol (TCP) connections (e.g., three connections) to the server are formed to download data dump 316.

After downloading data dump 316, downloader and chunker 308 may decompress data dump 316 to obtain an uncompressed version of data dump 316. Downloader and chunker 308 may also convert the uncompressed version of data dump 316 to another file format, which enables data dump 316 to be processed in a parallel fashion. For instance, in an embodiment in which data dump 316 is stored as a JSON structure, the entire JSON structure would have to be read in order to process it. Given that the size of the JSON structure may be 1-2 terabytes, processing such a structure would be too time consuming and compute extensive. To obviate such issues, downloader and chunker 308 may convert the JSON structure to a newline-delimited file format such that each entity of the plurality of entities in the JSON structure is specified on a separate, independently-processable line. An example of such a newline-delimited file format is the JSON Lines (JSONL) format. To convert the JSON structure to a JSONL file, downloader and chunker 308 may remove the square brackets at the beginning and end of the JSON structure and may remove the commas after each line. By doing so, each entity in the resulting JSONL file becomes independently-processable. In yet another embodiment, data dump 316 is parsed using a streaming JSON parser that parses data dump 316 in a streaming manner without having to read the entire JSON file.

After converting data dump 316 to a newline-delimited file format, downloader and chunker 308 may partition data dump 316 into a plurality of independently-processable partitions (or chunks) 318, where each partition specifies a respective subset of the plurality of entities of data dump 316 (e.g., each partition may comprise an N number of lines of the JSONL file, where N is any positive integer). In an embodiment, each of the partitions is uploaded to a storage repository (e.g., cloud-based storage repository) in a parallel fashion for subsequent processing.

Ontology classification and compaction component 310 may be configured to read each of partitions 318 (e.g., from the storage repository) and classify entities in each of partitions 318 in accordance with ontology 314. Ontology classification and compaction component 310 may read each of partitions 318 in a distributed manner and classify the entities therein in parallel. For instance, for each entity of a particular partition, ontology classification and compaction component 310 may classify the entity as being associated with one or more entity classes by analyzing the properties of the entity and determining whether any properties of the entity associate it to a given entity class. In an example in which data dump 316 is a Wikidata™ knowledge base, ontology classification and compaction component 310 may analyze each entity and determine whether it has a P31 property, which indicates whether the entity is an instance of a particular entity class (e.g., film).

In the event that a particular entity does not belong to a particular entity class, the particular entity may be classified as being unassigned. Unassigned entities may be stored for subsequent processing. In some embodiments, entity builder 312 references these unassigned entities while processing and extracting various properties of an entity. The various properties of the entity may refer to an unclassified entity that is to be retrieved and processed to continue further computation. For instance, in an example in which data dump 316 is a Wikidata™ knowledge base, to extract performer names for a musical album, the QIDs associated with the P175 property of a musical album entity may be referenced to extract the labels associated with the performers entities.

Ontology classification and compaction component 310 may also be configured to compact (and/or compress) each entity in a partition by discarding unnecessary data and reducing the verbosity of the entity. In some embodiments, where data dump 316 is an instance of a Wikidata™ knowledge base, ontology classification and compaction component 310 may reduce the p_values sub data structure for each entity to a simple map of the Wikidata™ property IDs and a sub structure of the relevant data extracted from the mainsnak sub-structure for that property. In yet some other embodiments, ontology classification and compaction component 310 may further process the extracted relevant data and order it by the precision property defined the mainsnak sub-structure.

Ontology classification and compaction component 310 may upsert (i.e., update or insert) each classified entity into a common database table of a database 322. Ontology classification and compaction component 310 may store the classified entity in a compacted form, as described above, thereby reducing the amount of storage required to store the classified entity and allow further distributed processing in a resource-optimized manner.

A new data dump may be released and made available periodically (e.g., once a week, once a month, etc.). Between data dump releases, the knowledge base may change. Rather than waiting for each data dump release, streaming cluster component 330 may communicate with streaming API 304, which may provide information 320 indicative of changes to the knowledge base in real-time (i.e., streaming cluster component 330 may determine changes to the knowledge base as soon as (or soon after) the knowledge base has been modified). In some embodiments, when data dump 316 is an instance of Wikidata™ knowledge base, such information 320 may indicate whether a new knowledge base item has been added (e.g., by providing the QIDs of the new items), whether an existing knowledge base item has been updated (e.g. by providing the QIDs of the updated items), and/or whether an existing knowledge base item has been deleted (e.g. by providing the QIDs of the deleted items), etc.

In an embodiment, streaming cluster component 328 may periodically send a request to streaming API 304 for such information 320. In another embodiment, streaming API 304 may automatically push such information 320 to streaming cluster component 330 in response to detecting a change to the knowledge base. In some embodiments, when data dump 316 is an instance of Wikidata™ knowledge base, information 320 may indicate the item QID and the operation type (such as add, delete or update). In response to obtaining such information 320 from streaming API 304, streaming cluster component 330 may use the QID and retrieve the latest version of the knowledge base item (shown as information 334) from knowledge base service 328. This information 334 may be provided in the same format as data dump 316 (e.g., via a JSON structure). Streaming cluster component 330 may aggregate information 320 and 334 and make the aggregated information (shown as aggregated information 336) available to ontology classification and compaction component 310 (e.g., shared via any commercially available cloud storage systems).

In some embodiments, ontology classification and compaction component 310 may read aggregated information 336, may classify and compact the entities indicated in information 336, and upsert such entities into the common database table of database 322. Entity builder 312 may be configured to extract various properties from each classified entity stored in the database table of database 322, for example, one entity class at a time. Entity builder 312 may extract additional data for each classified entity based on the properties associated therewith. In an example in which the entity class is a film, such properties may identify information such as which cast members, screenwriters, directors, producers, etc. are associated with the film. Entity builder 312 may also analyze the properties associated with the identified information to determine further information associated with the film. Such information may be joined and stored in a database table of a database 324. Each entity class may be stored in its own database table of database 324. In one embodiment, database 322 and database 324 are the same database. In another embodiment, database 322 and database 324 are different databases. In a further embodiment, database 324 may store database tables in a high-performance format for relatively large analytic tables suitable for big data.

In embodiments when data dump 316 is an instance of Wikidata™ knowledge base, pageviews downloader component 332 may download knowledge base pageviews 334 for webpages associated with each entity. Pageviews downloader component 332 may download knowledge base pageviews 338 periodically (e.g., daily, weekly, monthly, etc.) For example, in an embodiment in which the knowledge base is Wikidata™, the webpages associated with each entity may include a Wikipedia™ page for the entity, a Wikivoyage™ page for the entity, a Wiktionary™ page for the entity, a Wikisource™ page for the entity, etc. If the number of pageviews over a period of time (e.g., the last two weeks) increases, this may be indication that the popularity of the entity is increasing. Pageviews downloader component 332 may aggregate the pageviews over a rolling window of any number of days (e.g., the last 14 days). The aggregated pageviews (shown as pageviews 326) is made available to entity builder 312. Entity builder 312 may associate pageviews 326 of an entity with the entity in the database table of database 324.

The data stored in database 324 may be used to attach popularity information (e.g., from pageviews 326) to entities of a data catalog of a streaming platform. For example, when a user queries the data catalog for movies starring a particular actor, the query results may be sorted based on the rolling popularity as determined from pageviews 326). Pageviews 326 may also be utilized to disambiguate voice search commands, such as when the user asks a streaming platform to play a particular title that can correspond to more than one entity (e.g., both a movie and a music track). In such cases, based on the existing user context, the returning results may be based on popularity, where the more popular entity is provided to the user first.

In another embodiment, rather than generating the ontology based on querying knowledge base query service 302, the ontology may be generated utilizing data dump 316. In such an embodiment, the entities of data dump 316 may be analyzed to determine the subclasses thereof (e.g., by examining the P279 Wikidata™ property).

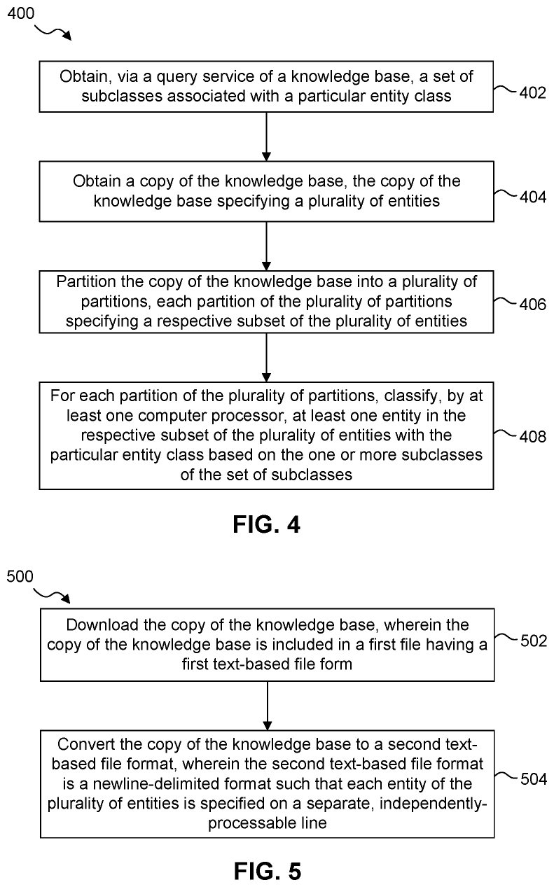

FIG. 4 is a flowchart for a method 400 for efficient entity classification, according to an embodiment. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to entity classifier component 128 of FIG. 3. However, method 400 is not limited to that example embodiment.

In 402, entity ontology builder 306 of entity classifier component 128 may obtain, via a query service of a knowledge base (e.g., knowledge base query service 302), a set of subclasses associated with a particular entity class.

In 404, downloader and chunker 308 of entity classifier component 128 may obtain a copy of the knowledge base (e.g., knowledge base data dump 316), the copy of the knowledge base specifying a plurality of entities.

In 406, downloader and chunker 308 may partition the copy of the knowledge base into a plurality of partitions, each partition of the plurality of partitions specifying a respective subset of the plurality of entities.

In 408, ontology classification and compaction component 310 of entity classifier component 128 may, for each partition of the plurality of partitions, classify at least one entity in the respective subset of the plurality of entities with the particular entity class based on the one or more subclasses of the set of subclasses.

In an embodiment, the particular entity class may comprise one of a film or a television series, the at least one entity may comprise a title of the one of the film or the television series, and the set of subclasses may comprise a plurality of further sub-classifications of the one of the film or the television series.

FIG. 5 is a flowchart for a method 500 for obtaining a copy of a knowledge base, according to an embodiment. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to entity classifier component 128 of FIG. 3. However, method 500 is not limited to that example embodiment.

In 502, downloader and chunker 308 of entity classifier component 128 may download the copy of the knowledge base (e.g., knowledge base data dump 316), wherein the copy of the knowledge base is included in a first file having a first text-based file format. In some embodiments, the first text-based file format is a JSON file format. It is noted, however, that other file formats may be utilized, including, but not limited to a binary format or a non-JSON format, such as an NT (N-Triples) or a TTL (Turtle) format.

In 504, downloader and chunker 308 may convert the copy of the knowledge base (e.g., knowledge base data dump 316) to a second text-based file format, wherein the second text-based file format is a newline-delimited format such that each entity of the plurality of entities is specified on a separate, independently-processable line of the output. In an embodiment, as discussed herein, the first text-based file format may be a JSON file format and the second-text based file format may be a JSONL format. In some embodiments, the converted output can be stored to a file. In yet some other embodiments, the converted output can be streamed to the next component in the pipeline using, but not limited to, software kernel-based facilities such as, but not limited to, UNIX-based pipes.

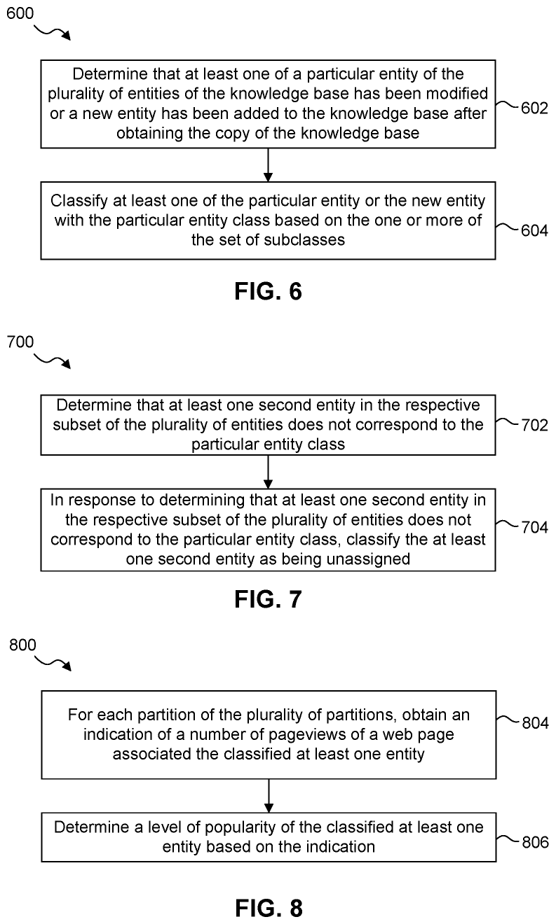

FIG. 6 is a flowchart for a method 600 for classifying a modified or new entity of the knowledge base, according to an embodiment. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to entity classifier component 128 of FIG. 3. However, method 600 is not limited to that example embodiment.

In 602, ontology classification and compaction component 310 of entity classifier component 128 may determine that at least one of a particular entity of the plurality of entities of the knowledge base has been modified or a new entity has been added to the knowledge base after obtaining the copy of the knowledge base (e.g., knowledge base data dump 316). For example, as discussed herein, ontology classification and compaction component 310 may also use information 336 available via streaming API 304 associated with the knowledge base that indicates that at least one of the particular entity of knowledge base has been modified or deleted or a new entity has been added to the knowledge base.

In 604, ontology classification and compaction component 310 may classify at least one of the particular entity or the new entity with the particular entity class based on the one or more of the set of subclasses.

FIG. 7 is a flowchart for a method 700 for classifying an entity as being unassigned, according to an embodiment. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to entity classifier component 128 of FIG. 3. However, method 700 is not limited to that example embodiment.

In 702, ontology classification and compaction component 310 may determine that at least one second entity in the respective subset of the plurality of entities does not correspond to the particular entity class.

In 704, ontology classification and compaction component 310 may, in response to determining that at least one second entity in the respective subset of the plurality of entities does not correspond to the particular entity class, classify the at least one second entity as being unassigned.

FIG. 8 is a flowchart for a method 800 for associating a number of pageviews with a classified entity, according to an embodiment. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to entity classifier component 128 of FIG. 3. However, method 800 is not limited to that example embodiment.

In 802, entity builder 312 of entity classifier component 128 may, for each partition of the plurality of partitions, obtain an indication of a number of pageviews 326 of a web page associated the classified at least one entity. In an embodiment, entity builder 312 may, for each partition of the plurality of partitions, store the classified at least one entity in association with the indication of the number of pageviews 326 in a database table (e.g., of database 324)

In 804, entity builder 312 may, for each partition of the plurality of partitions, determine a level of popularity of the classified at least one entity based on the indication.

### Example Computer System

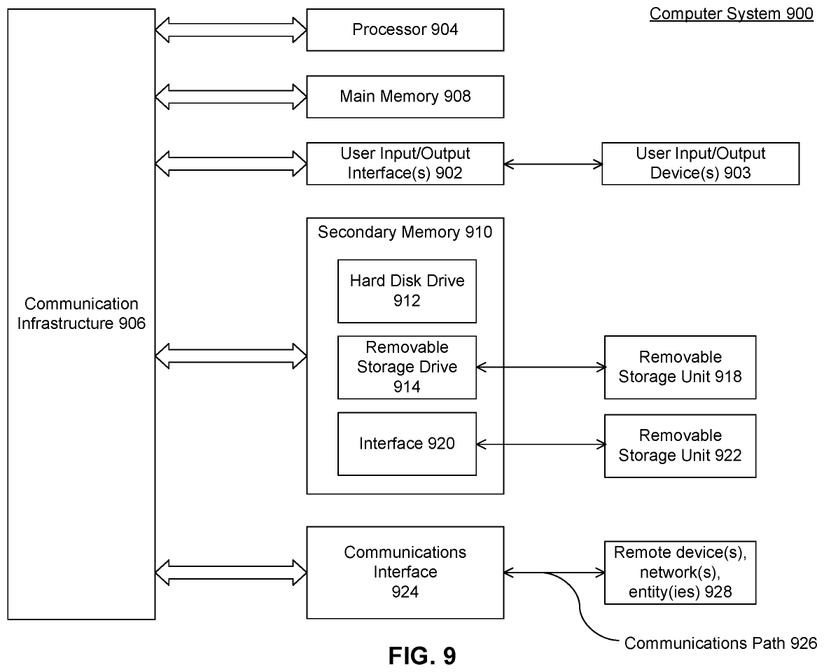

Various embodiments may be implemented, for example, using one or more well-known computer systems, such as computer system 900 shown in FIG. 9. For example, one or more of media device 106, remote control 110, content server(s) 120, system server(s) 126, entity classifier component 128, entity ontology builder 306, downloader and chunker 308, ontology classification and compaction component 310, entity builder 312, database 322, and database 324, may be implemented using combinations or sub-combinations of computer system 900. Also or alternatively, one or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900 or processor(s) 904), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for efficient entity classification, comprising:
obtaining, via a query service of a knowledge base, a set of subclasses associated with a particular entity class;
obtaining a copy of the knowledge base, the copy of the knowledge base specifying a plurality of entities;
partitioning the copy of the knowledge base into a plurality of partitions, each partition of the plurality of partitions specifying a respective subset of the plurality of entities; and
for each partition of the plurality of partitions:
classifying, by at least one computer processor, at least one entity in the respective subset of the plurality of entities with the particular entity class based on the one or more subclasses of the set of subclasses.

2. The computer-implemented method of claim 1, wherein obtaining the copy of the knowledge base comprises:
downloading the copy of the knowledge base, wherein the copy of the knowledge base is included in a first file having a first text-based file format; and
converting the copy of the knowledge base to a second text-based file format, wherein the second text-based file format is a newline-delimited format such that each entity of the plurality of entities is specified on a separate, independently-processable line.

3. The computer-implemented method of claim 2, wherein the first text-based file format is a JavaScript Object Notation (JSON) file format and the second-text based file format is a JSON Lines format.

4. The computer-implemented method of claim 1, further comprising:
determining that at least one of a particular entity of the plurality of entities of the knowledge base has been modified or a new entity has been added to the knowledge base after obtaining the copy of the knowledge base; and
classifying at least one of the particular entity or the new entity with the particular entity class based on the one or more of the set of subclasses.

5. The computer-implemented method of claim 4, wherein determining that at least one of the particular entity of the plurality of entities of the knowledge base has been modified or the new entity has been added to the knowledge base comprises:
obtaining a notification from a streaming application programming interface (API) associated with the knowledge base that indicates that at least one of the particular entity of knowledge base has been modified or the new entity has been added to the knowledge base.

6. The computer-implemented method of claim 1, further comprising:
determining that at least one second entity in the respective subset of the plurality of entities does not correspond to the particular entity class; and
in response to determining that at least one second entity in the respective subset of the plurality of entities does not correspond to the particular entity class, classifying the at least one second entity as being unassigned.

7. The computer-implemented method of claim 1, further comprising:
for each partition of the plurality of partitions:
obtaining an indication of a number of pageviews of a web page associated the classified at least one entity; and
determining a level of popularity of the classified at least one entity based on the indication.

8. The computer-implemented method of claim 1, wherein the particular entity class comprises one of a film or a television series, wherein the at least one entity comprises a title of the one of the film or the television series, and wherein the set of subclasses comprises a plurality of further sub-classifications of the one of the film or the television series.

9. A system for efficient entity classification, comprising:
one or more memories; and
at least one processor each coupled to at least one of the one or more memories and configured to perform operations comprising:
obtaining, via a query service of a knowledge base, a set of subclasses associated with a particular entity class;
obtaining a copy of the knowledge base, the copy of the knowledge base specifying a plurality of entities;
partitioning the copy of the knowledge base into a plurality of partitions, each partition of the plurality of partitions specifying a respective subset of the plurality of entities; and
for each partition of the plurality of partitions:
classifying at least one entity in the respective subset of the plurality of entities with the particular entity class based on the one or more subclasses of the set of subclasses.

10. The system of claim 9, wherein obtaining the copy of the knowledge base comprises:
downloading the copy of the knowledge base, wherein the copy of the knowledge base is included in a first file having a first text-based file format; and
converting the copy of the knowledge base to a second text-based file format, wherein the second text-based file format is a newline-delimited format such that each entity of the plurality of entities is specified on a separate, independently-processable line.

11. The system of claim 10, wherein the first text-based file format is a JavaScript Object Notation (JSON) file format and the second-text based file format is a JSON Lines format.

12. The system of claim 9, the operations further comprising:
determining that at least one of a particular entity of the plurality of entities of the knowledge base has been modified or a new entity has been added to the knowledge base after obtaining the copy of the knowledge base; and
classifying at least one of the particular entity or the new entity with the particular entity class based on the one or more of the set of subclasses.

13. The system of claim 12, wherein determining that at least one of the particular entity of the plurality of entities of the knowledge base has been modified or the new entity has been added to the knowledge base comprises:
obtaining a notification from a streaming application programming interface (API) associated with the knowledge base that indicates that at least one of the particular entity of knowledge base has been modified or the new entity has been added to the knowledge base.

14. The system of claim 9, the operations further comprising:
determining that at least one second entity in the respective subset of the plurality of entities does not correspond to the particular entity class; and
in response to determining that at least one second entity in the respective subset of the plurality of entities does not correspond to the particular entity class, classifying the at least one second entity as being unassigned.

15. The system of claim 9, the operations further comprising:
for each partition of the plurality of partitions:
obtaining an indication of a number of pageviews of a web page associated the classified at least one entity; and
determining a level of popularity of the classified at least one entity based on the indication.

16. The system of claim 9, wherein the particular entity class comprises one of a film or a television series, wherein the at least one entity comprises a title of the one of the film or the television series, and wherein the set of subclasses comprises a plurality of further sub-classifications of the one of the film or the television series.

17. A non-transitory computer-readable medium having instructions stored thereon that, when executed by at least one computing device, cause the at least one computing device to perform operations comprising:
obtaining, via a query service of a knowledge base, a set of subclasses associated with a particular entity class;
obtaining a copy of the knowledge base, the copy of the knowledge base specifying a plurality of entities;
partitioning the copy of the knowledge base into a plurality of partitions, each partition of the plurality of partitions specifying a respective subset of the plurality of entities; and
for each partition of the plurality of partitions:
classifying at least one entity in the respective subset of the plurality of entities with the particular entity class based on the one or more subclasses of the set of subclasses.

18. The non-transitory computer-readable medium of claim 17, wherein obtaining the copy of the knowledge base comprises:
downloading the copy of the knowledge base, wherein the copy of the knowledge base is included in a first file having a first text-based file format; and
converting the copy of the knowledge base to a second text-based file format, wherein the second text-based file format is a newline-delimited format such that each entity of the plurality of entities is specified on a separate, independently-processable line.

19. The non-transitory computer-readable medium of claim 18, wherein the first text-based file format is a JavaScript Object Notation (JSON) file format and the second-text based file format is a JSON Lines format.

20. The non-transitory computer-readable medium of 17, the operations further comprising:
determining that at least one of a particular entity of the plurality of entities of the knowledge base has been modified or a new entity has been added to the knowledge base after obtaining the copy of the knowledge base; and
classifying at least one of the particular entity or the new entity with at the particular entity class based on the one or more of the set of subclasses.
